(19) United States
(12) Patent Application Publication
(10) Pub. No.: US 2011/0091262 A1
(43) Pub. Date: Apr. 21, 2011

(54) IMAGE FORMING APPARATUS

(75) Inventors: Junichi MIYAI, Wakayama (JP); Hideya MIYAZAKI, Wakayama (JP)

(73) Assignee: NORITSU KOKI CO., LTD., Wakayama-shi (JP)

(21) Appl. No.: 12/903,608

(22) Filed: Oct. 13, 2010

(30) Foreign Application Priority Data
Oct. 19, 2009 (JP) 2009-240099

(51) Int. Cl. B41J 11/70

(52) U.S. Cl. 400/621

(57) ABSTRACT

An image forming apparatus feeding paper and forming an image on the paper includes: a cutting unit configured to cut the paper located on a feeding path to feed a sheet of paper subjected to the image formation; and a brushing unit arranged on the upstream side in the paper feeding direction with respect to the cutting unit and after the cutting unit cuts the paper, brushing down, from the feeding path, a piece of waste paper left near the cutting unit on the upstream side in the paper feeding direction with respect to the cutting unit on the feeding path.

### CROSS-REFERENCE TO RELATED APPLICATION

This application claims priority to Japanese Patent Application No. 2009-240099 filed on Oct. 19, 2009, the disclosure of which including the specification, the drawings, and the claims is hereby incorporated by reference in its entirety.

### BACKGROUND

The present disclosure relates to an image forming apparatus capable of feeding paper and forming an image on the paper.

In a conventional image forming apparatus employed for a photographic print system or the like, a roll of long paper is stored in a magazine, and the paper stored in the magazine is supplied to a printing section and is printed by a print head of an ink jet type or the like. The printed paper is cut by a cutting unit such that the cut-off sheet has a predetermined length and is fed to a discharge position where a discharge tray or the like is provided (e.g., refer to Japanese Patent Publication No. 2004-216651 and Japanese Patent Publication No. 2007-261038).

In Japanese Patent Publication No. 2004-216651, a blank part is provided in a front-edge part of paper, and when the paper is printed, the blank part blocks absorption holes (suction holes) for absorbing the paper. Therefore, when ink is discharged from a print head toward a front-edge part of the paper, the ink is prevented from being sucked into the absorption holes blocked with the blank part, thereby suppressing a fall in the precision with which the ink hits the target. Specifically, without the blank part, the ink discharged toward nearly the front edge of the paper would be more easily sucked into the absorption holes immediately downstream from the front edge, thereby lowering the target-hitting precision of the ink in the front-edge part of the paper. However, the blank part is useful for preventing a fall in the target-hitting precision of the ink in the front-edge part of the paper.

Once a front-edge part of the paper is drawn from a magazine, the paper keeps blocking the absorption holes until the paper is cut and then rolled and returned into the magazine after printed. Therefore, a fall in the target-hitting precision of the ink can be avoided in a middle part of the paper.

In a rear-edge part of the paper, similarly to the front-edge part thereof, the ink may be sucked into the absorption holes upstream from the rear edge of the paper to lower the target-hitting precision of the ink. However, no such problem arises if the long paper is used, because the rear-edge part of the long paper is problematic in the respect of quality and is not used for printing in the first place. Hence, when the rear-edge part of the long paper is detected by a sensor or the like, the rear-edge part is collected as an unusable part without being printed.

Japanese Patent Publication No. 2004-216651 discloses a so-called guillotine cutter as a cutting unit cutting off a blank part of paper. The guillotine cutter includes a fixed blade and a moving blade arranged vertically such that the paper is sandwiched between. The moving blade is pressed against the paper to cut the paper by the sheering force. In addition, Japanese Patent Publication No. 2007-261038 discloses a roller cutter which cuts the paper by moving a round blade from one end to the other end of the paper in the width directions while rotating the round blade.

### SUMMARY

However, in the above image forming apparatuses, in addition to the long paper, paper (a sheet of paper) cut off in advance and having a predetermined size can be used. When the sheet of paper undergoes no-margin printing (the whole sheet of paper is printed), a blank part is provided in each of front-edge and rear-edge parts of the sheet of paper, thereby avoiding a fall in the precision with which the ink hits the target in the front-edge and rear-edge parts of the sheet of paper. Then, the cutting unit (such as the guillotine cutter and the roller cutter) cuts off the blank parts of the front-edge and rear-edge parts of the sheet of paper.

In the case where the cutting unit cuts off the blank parts of the front-edge and rear-edge parts of the sheet of paper, the blank part of the front-edge part is cut off to produce a piece of waste paper (a rectangular piece of paper corresponding to the blank part of the front-edge part). The piece of waste paper is usually collected into a trash can provided thereunder without being left on the feeding path. On the other hand, a piece of waste paper (a rectangular piece of paper corresponding to the blank part of the rear-edge part) produced by cutting off the blank part of the rear-edge part may be left on a guide member (i.e., on the feeding path) which is arranged on the upstream side in the paper feeding direction with respect to the cutting unit and forms a part of the feeding path. Even if the piece of waste paper is left on the feeding path, the piece of waste paper may be pushed out by a succeeding sheet of paper fed one after another and be collected into the trash can. However, there is no guarantee that the piece of waste paper will be collected into the trash can. For example, if the piece of waste paper is curled, then a succeeding sheet of paper may go onto the piece of waste paper, or the piece of waste paper may hinder the advance of the succeeding sheet of paper. This may cause the piece of waste paper and the succeeding sheet of paper to be stuck fast on the feeding path.

If the piece of waste paper cut off by the cutting unit is left on the feeding path, then a succeeding sheet of paper may be deflected on the feeding path while being printed, thereby changing the distance between the print head and the surface to be printed thereof or causing interference thereof with the print head. This leaves room for improvement.

In view of the foregoing, it is an object of the present invention to provide an image forming apparatus capable of certainly collecting a piece of waste paper left on the feeding path after paper is cut by a cutting unit.

In order to accomplish the object, an image forming apparatus of the present invention which feeds paper and forms an image on the paper includes: a cutting unit configured to cut the paper located on a feeding path to feed a sheet of paper subjected to the image formation; and a brushing unit arranged on the upstream side in the paper feeding direction with respect to the cutting unit and after the cutting unit cuts the paper, brushing down, from the feeding path, a piece of waste paper left near the cutting unit on the upstream side in the paper feeding direction with respect to the cutting unit on the feeding path.

According to this configuration, after a blank part in a rear-edge part of a sheet of paper is cut off, even if the piece of waste paper is left on the feeding path, the brushing unit brushes down the piece of waste paper forcedly from the feeding path. Specifically, the cutting unit cuts off the blank part of the rear-edge part of the sheet of paper, and thereby, the piece of waste paper may be left near the cutting unit on the upstream side in the paper feeding direction with respect to the cutting unit on the feeding path (e.g., on a guide member). However, the brushing unit brushes down the piece of waste paper, and if a trash can is placed under the cutting unit, the piece of waste paper surely falls into the trash can. This prevents the piece of waste paper from hindering the advance of a succeeding sheet of paper.

In the above image forming apparatus, it is preferable that the brushing unit includes a brushing member brushing down the piece of waste paper, and a position switching unit switching the position of the brushing member from a standby position where the brushing member retreats from the feeding path for the paper to a brushing position where the brushing member comes into the feeding path and brushes down the piece of waste paper, and vice versa.

According to this configuration, paper is permitted to be fed when the brushing member is in the standby position. Specifically, in feeding the paper, the brushing member will not hamper the feeding of the paper, thereby realizing smooth feeding of the paper. On the other hand, when the brushing member is in the brushing position, the brushing member is capable of brushing down a piece of waste paper.

It is preferable that the position switching unit switches the position of the brushing member before the cutting unit cuts the paper to a preparation position which is on the upstream side in the paper feeding direction with respect to the brushing position and in which the brushing member comes into the feeding path.

According to this configuration, the brushing member is brought to the preparation position before a sheet of paper is cut, thereby preventing the piece of waste paper from going upstream in the paper feeding direction from the brushing member. Specifically, if the cutting unit cuts off a blank part of a rear-edge part of the sheet of paper with the brushing member located in the standby position, the piece of waste paper may go upstream in the paper feeding direction along the feeding path. This makes it impossible for the brushing member to brush down the piece of waste paper. Therefore, the brushing member is brought to the preparation position before the sheet of paper is cut, and thereby, even if the piece of waste paper goes upstream in the paper feeding direction, the piece of waste paper comes into contact with the brushing member located in the preparation position and cannot go upstream in the paper feeding direction from the brushing member. As a result, the brushing member can certainly brush down the piece of waste paper.

### BRIEF DESCRIPTION OF THE DRAWINGS

FIG. 1 is a perspective view showing an external appearance of an ink jet printer as an image forming apparatus according to an embodiment of the present invention.

FIG. 2 is a schematic side view showing an internal configuration of the ink jet printer.

FIG. 3 is a side view showing a main part of a magazine with an opening portion of the magazine kept closed.

FIG. 4 is a side view showing the main part of the magazine of FIG. 3 with the opening portion kept open.

FIG. 5 is a plan view showing a configuration of a platen in a printing section.

FIG. 6 is a side view showing a configuration of the printing section and a cap section.

FIG. 7 is a plan view showing a configuration of a brushing unit.

FIGS. 8A and 8B are side views showing the brushing unit located in a standby position, indicating the position of a first detection sensor and the position of a second detection sensor respectively.

FIGS. 9A and 9B are side views showing the brushing unit located in a preparation position, indicating the position of the first detection sensor and the position of the second detection sensor respectively.

FIGS. 10A and 10B are side views showing the brushing unit located in a brushing position, indicating the position of the first detection sensor and the position of the second detection sensor respectively.

FIG. 11 is a schematic view showing a switchback roller pair of a switchback section receiving paper fed from a feeding roller pair.

FIG. 12 is a schematic view showing a driven roller of the switchback roller pair of FIG. 11 being brought to a second position.

### DETAILED DESCRIPTION

An illustrative embodiment of the present invention will be below described in detail with reference to the drawings. The following description of the illustrative embodiment is essentially provided only for an illustration, and hence, the present invention, the one applied thereto or the use thereof is not supposed to be limited.

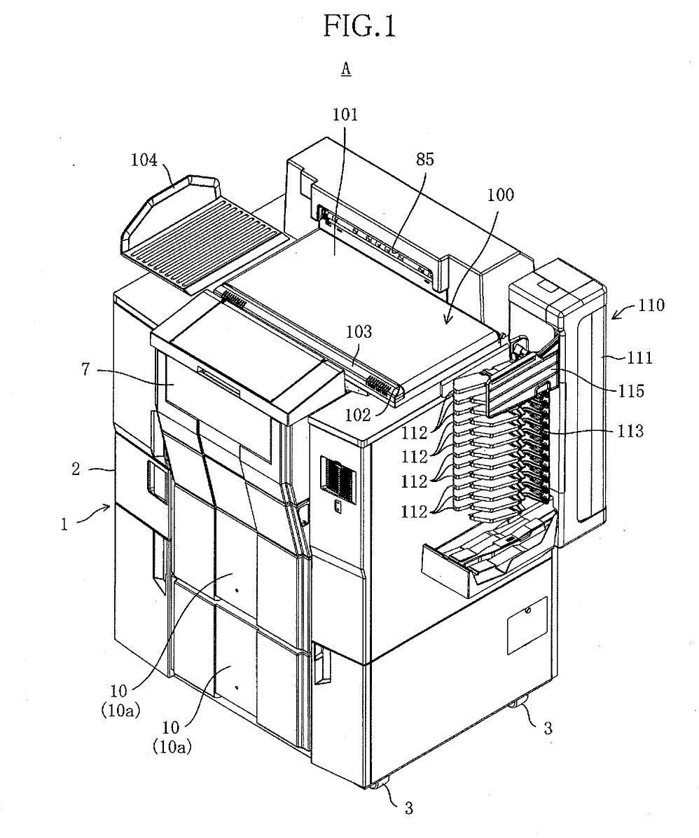

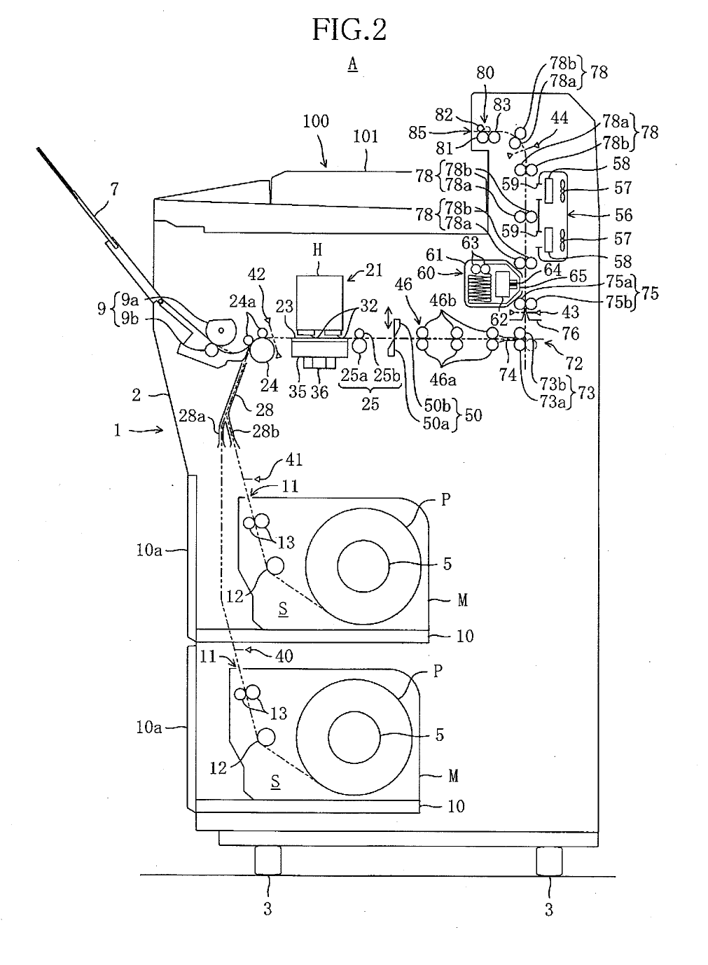

FIG. 1 is a perspective view showing an external appearance of an ink jet printer A as an image forming apparatus according to the illustrative embodiment. FIG. 2 is a schematic side view showing an internal configuration of the ink jet printer A.

As shown in FIGS. 1 and 2, the ink jet printer A is employed for a photographic print system and for example, prints (forms an image on) paper P on the basis of image data transmitted through a communication cable from an acceptance block (not shown) acquiring image data and executing a required correction processing or the like.

The ink jet printer A includes a printer body section 1 formed by a casing 2 and casters 3 provided in the bottom surface thereof. The casing 2 of the printer body section 1 houses two magazines M vertically arranged in the lower part thereof, and a roll of the long paper P is storable in each magazine M.

In the illustrative embodiment, the side (the left side of FIG. 2) of the printer body section 1 on which a manual tray 7 (described later) lies corresponds to the printer front side, while the opposite side (the right side of FIG. 2) thereof corresponds to the printer rear side. In FIG. 2, the right-and-left directions correspond to the printer front-and-rear directions, and the directions perpendicular to the paper surface of FIG. 2 correspond to the printer right-and-left directions and are identical with the width directions of the paper P fed inside of the casing 2 of the printer body section 1.

The magazine M is a portable and substantially-closed box-shaped container and the long paper P rolled around a roll core 5 is stored in a storage chamber S inside of the magazine M. The upper face of the magazine M is formed at an edge part thereof on the printer front side with an opening portion 11 for drawing the paper P stored in the magazine M from the magazine M. The opening portion 11 has a substantially rectangular shape extending in the same directions (the width directions of the paper P) as the roll core 5.

The magazine M includes a magazine roller 12 for sending the paper P out of the storage chamber S through the opening portion 11. The paper P sent out using the magazine roller 12 is delivered to a supply roller 24 (described later).

The magazine M also includes a holding roller pair 13 between the opening portion 11 and the magazine roller 12 which holds the paper P drawn from the roll core 5 inside of the magazine M. The holding roller pair 13 holds a front-edge part of the paper P between in the magazine M, thereby restraining the front-edge part of the paper P from moving freely inside of the magazine M. This is helpful in preventing the rolled paper P from coming loose or a surface to be printed of the paper P from rubbing against the inner bottom surface of the magazine M.

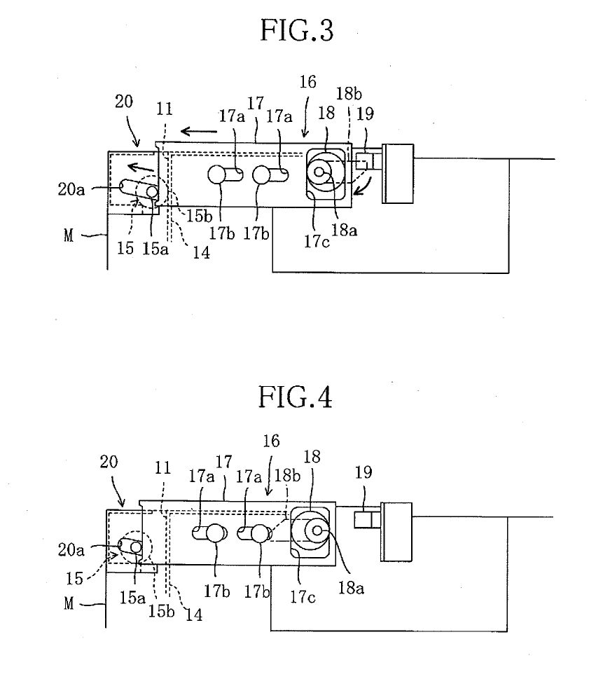

FIG. 3 is a side view showing a main part of the magazine M with the opening portion 11 of the magazine M kept closed. As shown in FIG. 3, the opening portion 11 of the magazine M is provided with an opening-and-closing shutter mechanism 20 opening and closing the opening portion 11. The opening-and-closing shutter mechanism 20 includes: a guide plate 14 for guiding the paper P drawn from the roll core 5 to the opening portion 11; a shutter roller 15 switching from a state where the shutter roller 15 is pressed against the guide plate 14 to a state where it is not pressed against the guide plate 14, and vice versa; and a cam mechanism 16 driving the shutter roller 15.

The shutter roller 15 opens or closes the opening portion 1 to permit or shut off a flow of air inside and outside of the magazine M and includes a shaft portion 15a extending along the opening portion 11 of the magazine M and a roller portion 15b arranged in the peripheral part of the shaft portion 15a and pressed against the guide plate 14. The shutter roller 15 is supported on an elongated hole 20a formed near the opening portion 11 in the side wall of the magazine M on each side in the printer right-and-left directions and is slidable via the shaft portion 15a. The shaft portion 15a of the shutter roller 15 is constantly forced toward the guide plate 14 by a forcing spring (not shown). Therefore, the peripheral surface of the roller portion 15b is pressed against the guide plate 14 to close the opening portion 11, and the shaft portion 15a is substantially in contact with the front-edge part of a slide plate 17 forming a part of the cam mechanism 16 (practically, there is a slight gap between them).

The cam mechanism 16 includes the slide plate 17 and an eccentric cam 18 driven by a cam drive motor (not shown). The slide plate 17 is formed with two elongated holes 17a extending in the printer front-and-rear directions. The slide plate 17 is provided with two guide shafts 17b each inserted through the corresponding elongated hole 17a. The guide shafts 17b protrude outward from the side wall of the magazine M on each side in the printer right-and-left directions and support the slide plate 17, thereby enabling the slide plate 17 to slide in the printer front-and-rear directions with supported on the guide shafts 17b.

The slide plate 17 is formed at an end part thereof on the printer rear side with a substantially-rectangular cam hole 17c, and the inner circumferential surface of the cam hole 17c is a contact surface coming into contact with the cam surface of the eccentric cam 18. The eccentric cam 18 is eccentrically attached to an output shaft 18a of the cam drive motor. The output shaft 18a of the cam drive motor is provided with a detection piece 18b, and thereby, a detection sensor 19 attached to the side wall of the magazine M on each side in the printer right-and-left directions detects a reference rotational position of the cam drive motor.

Next, an operation of the above opening-and-closing shutter mechanism 20 will be specifically described. First, in the state (where the opening portion 11 is closed) shown in FIG. 3, the eccentric part of the eccentric cam 18 is located on the printer rear side with respect to the output shaft 18a of the cam drive motor. If the eccentric cam 18 rotates clockwise in FIG. 3, the eccentric part of the eccentric cam 18 is located on the printer front side with respect to the output shaft 18a of the cam drive motor (see FIG. 4). At this time, the eccentric cam 18 presses the cam hole 17c of the slide plate 17 toward the printer front side, and thereby, the slide plate 17 moves along the guide shafts 17b toward the printer front side.

As a result, the shaft portion 15a of the shutter roller 15 is pressed by the front-edge part of the slide plate 17 and moves toward the printer front side against the force of the forcing spring. Hence, the roller portion 15b of the shutter roller 15 moves toward the printer front side to form a gap between the roller portion 15b and the guide plate 14 and open the opening portion 11.

Only when the ink jet printer A is in operation, the eccentric cam 18 of the opening-and-closing shutter mechanism 20 rotates to move the shutter roller 15, and thereby, the opening portion 11 is forcedly opened. Therefore, when the ink jet printer A is not in operation, the opening portion 11 of the magazine M is not supposed to be left open for a long time, thereby preventing air inside of the magazine M from being dried and protecting the paper P inside of the magazine M against a crack or the like.

As shown in FIG. 2, the magazine M is placed on a slide table 10 provided in the casing 2 and slidable in the printer front-and-rear directions. The slide table 10 is slidable in the printer front-and-rear directions on linear guides (not shown) or the like provided on both sides in the printer right-and-left directions inside of the casing 2 and extending in the printer front-and-rear directions. The slide table 10 is slid to set the magazine M into and out of the casing 2. The face of the slide table 10 on the printer front side forms a part of the casing 2 and is covered with a door member 10a freely opened and closed, and the door member 10a is opened to replace the paper P. The printer front-side part of the slide table 10 for the upper magazine M has a cutout (not shown) for leading in the paper P drawn from the lower magazine M.

In an upper part (above the upper magazine M) inside of the casing 2, a printing section 21 is provided which prints (forms an image on) the paper P drawn from the storage chamber S of the magazine M on the basis of image data.

A guide member 28 for leading the paper P to the printing section 21 is provided between the magazine M and the printing section 21. The guide member 28 prevents the front-edge part of the paper P from slipping out of place when it passes through a feeding path and goes toward the supply roller 24. The guide member 28 is provided at the upstream end thereof in the feeding direction of the paper P with two first and second branch paths 28a and 28b. The paper P drawn from the lower magazine M is inserted through the first branch path 28a and the paper P drawn from the upper magazine M is inserted through the second branch path 28b. Therefore, the paper P stored in each of the vertically-arranged magazines M passes through the separate feeding path, finally joins together and reaches the supply roller 24.

A first sensor 40 and a second sensor 42 are provided between the guide member 28 and the magazines M respectively, and the sensors 40 and 42 are of a reflection type and detect the front edge of the paper P being drawn from the magazine M.

The manual tray 7 for an operator manually supplying paper (a sheet of paper) cut off in advance and having a predetermined size is provided in an upper part on the printer front side of the printer body section 1. As shown in FIG. 1, the manual tray 7 is folded into the casing 2 when it is not used.

A manual roller pair 9 is provided on the printer rear side from the manual tray 7. The manual roller pair 9 is formed by a driving roller 9a coming into contact with the surface (the upper surface) of a sheet of paper manually supplied to the manual tray 7 on which the printing section 21 prints an image, and a driven roller 9b coming into contact with the reverse surface (the lower surface) thereof. A manual-roller drive motor (not shown) drives the driving roller 9a to rotate the manual roller pair 9 and send the sheet of paper manually supplied to the manual tray 7 toward the supply roller 24.

The ink jet printer A of the illustrative embodiment is configured to print both the paper P stored in the storage chamber S of the magazine M and the manually-supplied sheet of paper and give one and the same processing to the paper after supplied to the supply roller 24. Therefore, the case where the paper P stored in the magazine M is fed and printed will basically be below described. However, when a configuration of a brushing unit 90 (described later) is explained, the case where the sheet of paper is fed will be described.

As shown in FIG. 2, the paper P supplied to the supply roller 24 is sent to the printing section 21 by the supply roller 24. Specifically, the paper P is held between the supply roller 24 and two pressure rollers 24a facing the supply roller 24, then the supply roller 24 is rotated clockwise in FIG. 2 by a supply-roller drive motor (not shown) and thereby the paper P is fed to the printing section 21.

The supply roller 24 is rotatable in both the forward and reverse directions by the supply-roller drive motor, and the forward rotation is for drawing the paper P from the storage chamber S of the magazine M and feeding it to the printing section 21 while the reverse rotation is for returning the drawn paper P into the storage chamber S. This makes it possible, for example, to stop halfway printing the paper P drawn from the magazine M on one side to the printing section 21 and return the paper P on the feeding path into the magazine M, and instead, supply the sheet of paper manually supplied to the manual tray 7 or the paper P inside of the magazine M on the other side to the printing section 21 and print there. In addition, if the paper P drawn to the printing section 21 from the magazine M needs to be replaced with new paper, the drawn paper P can be returned into the magazine M.

The printing section 21 is arranged downstream from the supply roller 24 in the feeding direction of the paper P and includes a print head H printing a surface to be printed of the paper P and a platen 23 supporting the paper P fed by the supply roller 24. The upstream side and the downstream side in the feeding direction of the paper P will be below called simply as the upstream side and the downstream side respectively.

On the downstream side with respect to the print head H, a pressure-type downstream roller pair 25 is provided which is formed by a driving roller 25a arranged under the horizontally-extending feeding path and a driven roller 25b arranged thereover. The driving roller 25a is driven by a downstream-roller drive motor (not shown).

The supply roller 24 is provided on the downstream side with a third sensor 42 (formed by a light-injection portion and a light-reception portion) detecting the front edge of the paper P sent from the supply roller 24. If it is judged from a detection result of the front edge of the paper P by the third sensor 42 that the supply roller 24 has fed the paper P by a certain distance from there and a printing-start part of the paper P has reached under the print head H, then the paper P starts to be printed. Further, if it is judged from a detection result of the front edge of the paper P by the third sensor 42 that the supply roller 24 has fed the paper P by a certain distance from there and the front edge of the paper P has reached the downstream roller pair 25, then the supply roller 24 changes from a pressing state to a non-pressing state and the downstream roller pair 25 changes from a non-pressing state to a pressing state. This time, the downstream roller pair 25 feeds the paper P.

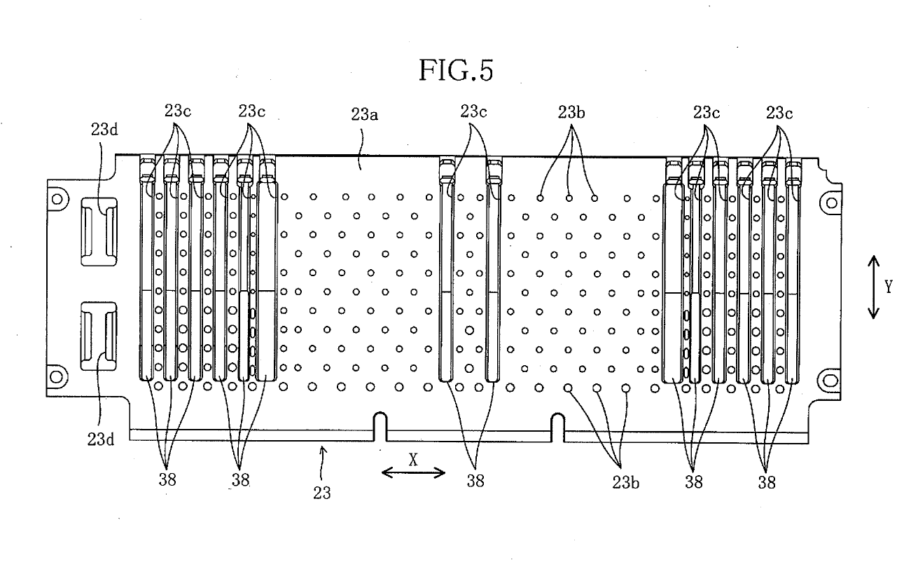

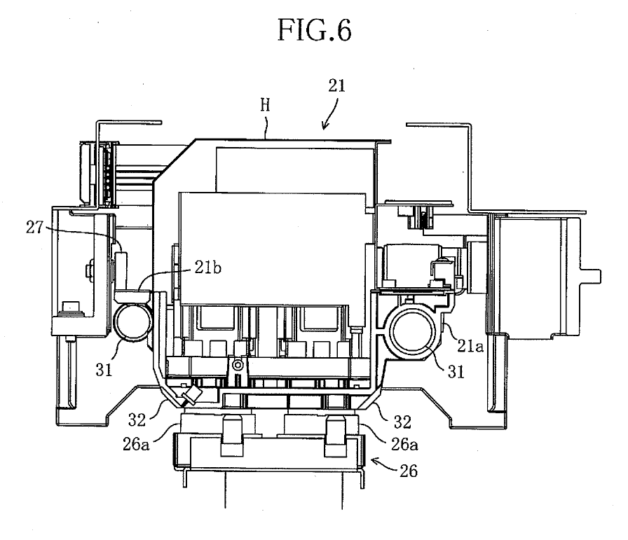

As shown in FIGS. 5 and 6, the print head H is movable along two guide rails 31 extending in main-scanning directions X identical to the width directions (the printer right-and-left directions) of the paper P over the paper P supported on the platen 23. The print head H includes two head units 32, 32 arranged side by side in sub-scanning directions Y perpendicular to the main-scanning directions X and identical to the movement directions (the printer front-and-rear directions) of the paper. The two head units 32, 32 are each provided at a lower face thereof with many ink discharge nozzles (not shown) discharging inks of a plurality of colors downward and printing a predetermined image on a surface to be printed of the paper P. In the illustrative embodiment, the two head units 32 are arranged side by side in the sub-scanning directions Y, but the number of head units is not limited to two and hence may be one, or three or more.

Both head units 32 have the same formation and each include a plurality of nozzle arrays arranged in the main-scanning directions X and discharging the ink of each color. In each nozzle array, the ink discharge nozzles are arranged in line in the sub-scanning directions Y, thereby enabling each single head unit 32 to print a color image. The paper P is fed intermittently (stepwise) by a fixed unit feeding distance in the sub-scanning directions Y by the supply roller 24 or the downstream roller pair 25. When the paper P comes to each halt while being intermittently fed, the print head H makes one scan (one forward motion or one backward motion) in the main-scanning directions X. At the time of each scan, the ink discharge nozzles for each color of each head unit 32 discharge inks simultaneously onto the upper surface of the paper P at each position in the main-scanning directions X. In other words, the paper P is fed by the unit feeding distance after the print head H makes one scan, and thereafter, the print head H makes another scan. Then, this operation is repeated to print a desired image on the upper surface of the paper P, and thereby, the upper surface of the paper P located in the printing section 21 becomes a printed surface.

Here, the print head H of the illustrative embodiment discharges an ink in an ordinary piezoelectric method. In this method, the volume inside of a pressure chamber filled with an ink is varied by a piezoelectric element, and thereby, the ink is discharged from an ink discharge nozzle communicating with the pressure chamber.

The platen 23 is a plate-shaped member and the upper surface thereof is a support surface 23a supporting the paper P. The platen 23 is formed with many suction holes 23b penetrating in the thickness directions (the up-and-down directions) thereof and opening in the support surface 23a. Under the platen 23, a case body 35 (see FIG. 2) forming a space together with the platen 23 is provided, and a suction device 36 (see FIG. 2) including a fan or the like is provided under the case body 35. The suction holes 23b communicates with the space inside of the case body 35 and this space communicates with the suction port of the suction device 36. The operation of the suction device 36 generates a negative pressure, through the suction holes 23b, on the support surface 23a of the platen 23, and thereby, the paper P is absorbed and held onto the support surface 23a of the platen 23. This makes it possible to flatten the paper P securely when it is printed and hence improve the print quality thereof.

The support surface 23a of the platen 23 is formed with concave portions 23c extending in the sub-scanning directions Y and each having an ink absorber 38 stored therein. In no-margin printing where an image is printed over the whole surface of the paper P, even if a part of ink discharged from the print head H (the head units 32) runs out of an edge of the paper P on the support surface 23a in the width directions, then the ink absorber 38 prevents the support surface 23a of the platen 23 from being dirtied with the part of ink. Hence, the concave portions 23c are arranged in the positions corresponding to the edges of the paper P on the support surface 23a in the width directions and the position corresponding to the print head H in the sub-scanning directions Y such that the concave portions 23c extend along those edges (i.e., in the sub-scanning directions Y). In the example of FIG. 5, the fourteen concave portions 23c in total are arranged.

In an edge part on one side (out of a printing range) of the platen 23 in the main-scanning directions X, a flashing hole 23d is formed at each position corresponding to the head units 32, 32 in the sub-scanning directions Y. In order to prevent ink thickening, the flashing hole 23d receives a small quantity of ink discharged from the nozzle of the print head H when printing starts to be conducted.

In a position out of the printing range of the print head H in the main-scanning directions X (sideward on the one side of the platen 23 in the main-scanning directions X), a standby position for holding the print head H on standby when it is not printing, and a cap portion 26 is provided in the standby position (see FIG. 6). When the print head H is not used, in order to prevent ink thickening, the cap portion 26 comes into close contact with the head units 32, 32 of the print head H. The cap portion 26 includes two suction caps 26a corresponding to the head units 32, 32 and placed in array in the sub-scanning directions Y. The cap portion 26 moves up and down between a position where it is in close contact with the bottom surface of the print head H and a position where it is separate from the bottom surface of the print head H.

On the printer rear side (the right side in FIG. 6) of the print head H, a bearing holder 21a for inserting the rear guide rail 31 through is provided, and thereby, the print head H is supported turnably on the rear guide rail 31. On the other hand, a head guide 21b protruding to the printer front side is provided on the printer front side (the left side in FIG. 6) of the print head H. The head guide 21b is placed slidably on the front guide rail 31 and supports the print head H together with the bearing holder 21a such that the print head H is kept horizontal. If the paper P is stuck fast between the print head H and the platen 23, then the operator can raise the front part of the print head H and turn the print head H about the rear guide rail 31, thereby making the maintenance thereof easier.

In the standby position of the print head H, a sandwiching roller 27 is provided above the front guide rail 31. The print head H moves to the standby position, and thereby, the head guide 21b of the print head H is held between the sandwiching roller 27 and the front guide rail 31. Therefore, in the standby position, the print head H is prevented from being forced up when the cap portion 26 moves up and comes into close contact with the bottom surface of the print head H. In the close-contact position, the cap portion 26 forms a negative-pressure space between the cap portion 26 and the bottom surface of the print head H and thereby sucks ink from the nozzle thereof. The sucked ink is collected in a waste liquid tank (not shown).

Four ink cartridges (not shown) each containing an ink different in hue are housed detachably in a lower part (on the right side if seen from the printer front side) inside of the casing 2. The ink cartridges are attached and detached to replace a cartridge now in use or a used cartridge with a new one. The ink cartridges contain inks of yellow (Y), magenta (M), cyan (C) and black (K) respectively.

As shown in FIG. 2, a cutting unit 50 is provided on the printer rear side (downstream from the printing section 21) with respect to the downstream roller pair 25. The cutting unit 50 cuts the paper P (and the sheet of paper) after printed located on the feeding path for feeding the paper P (and the sheet of paper). The cutting unit 50 is formed by a fixed blade 50a arranged under the feeding path and a moving blade 50b arranged over the feeding path and moved vertically with respect to the fixed blade 50a by a cutter drive motor (not shown). The moving blade 50b moves from above to below the paper P (and the sheet of paper) to cut the paper P (and the sheet of paper).

The cutting unit 50 cuts, for example, the paper P after printed such that the cut-off sheet has a predetermined size (however, the sheet of paper manually supplied to the manual tray 7 is not subjected to the cutoff), or cuts off blank parts in a front-edge part and a rear-edge part of the sheet of paper in no-margin printing (first cuts off the blank part of the front-edge part and then cuts off the blank part of the rear-edge part).

A piece of waste paper (a rectangular piece of paper corresponding to the blank part of the front-edge part) produced by cutting off the blank part of the front-edge part of the sheet of paper falls into a trash can (not shown) arranged in the lower part of the casing 2 (under the cutting unit 50) and is stored therein. On the other hand, a piece of waste paper (a rectangular piece of paper corresponding to the blank part of the rear-edge part) produced after the cutting unit 50 cuts off the blank part of the rear-edge part of the sheet of paper may be left near the cutting unit 50 (between end parts on the downstream side of the upper and lower guide members 91 (described later)) on the upstream side in the paper feeding direction with respect to the cutting unit 50 on the feeding path for feeding the sheet of paper after printed.

Therefore, in the illustrative embodiment, the brushing unit 90 brushing down the piece of waste paper from the feeding path is provided upstream from the cutting unit 50. A configuration of the brushing unit 90 will be below described.

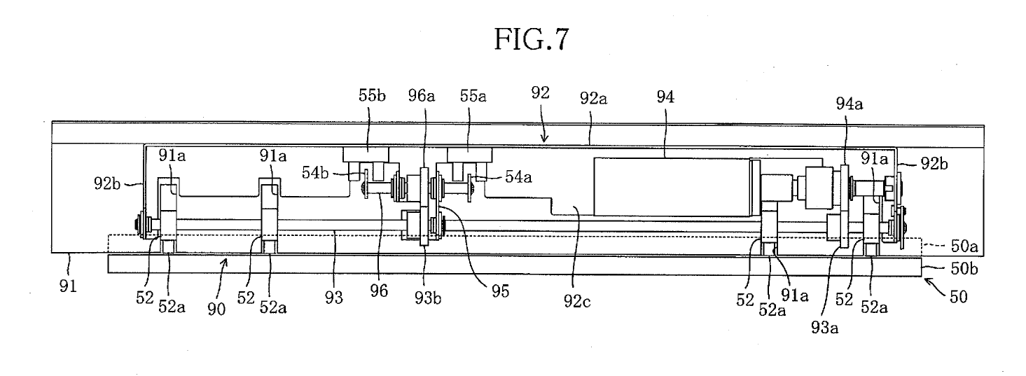

As shown in FIG. 7, the pair of upper and lower guide members 91 sandwiching the feeding path is provided upstream from the cutting unit 50 (and downstream from the printing section 21). The guide members 91 are used for guiding the sheet of paper (and the paper P) up to the cutting unit 50. The front-edge parts of the guide members 91 are bent obliquely upward and downward respectively such that the insertion port for the sheet of paper widens toward the upstream side. The brushing unit 90 is arranged above the guide members 91.

The brushing unit 90 includes a body portion 92 formed by a base portion 92c having a flat-plate shape and is fixed on the upper guide member 91, a front side wall 92a erected at the edge of the body portion 92 on the printer front side, and right and left side walls 92b erected at both edges of the body portion 92 in the printer right-and-left directions. A rotating shaft 93 extending in the printer right-and-left directions is supported at both ends thereof by the right and left side walls 92b of the body portion 92 such that the rotating shaft 93 is rotatable. The rotating shaft 93 is provided with four brushing members 52, a motor connection gear 93a and a sensor connection gear 93b which are arranged apart from each other in the axial directions of the rotating shaft 93 and are unitedly rotated.

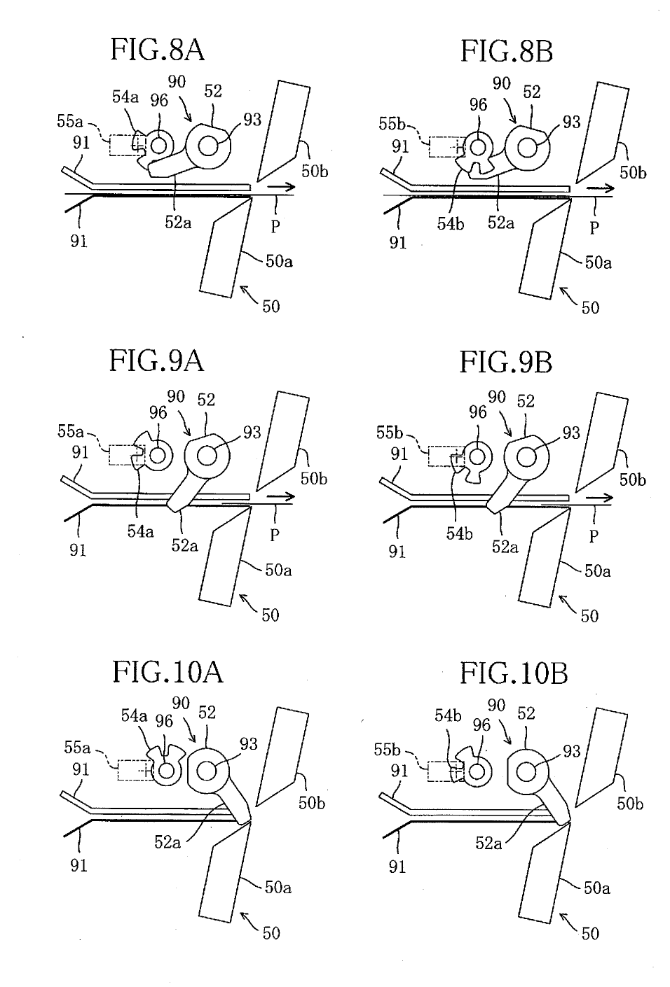

The brushing members 52 are members brushing down the piece of waste paper and each include a front end portion 52a protruding in the radial directions of the rotating shaft 93 (see FIGS. 8A, 8B and the like). As the rotating shaft 93 rotates, the brushing members 52 (the front end portions 52a) are interlocked and turned with the rotating shaft 93, and thereby, the turning position thereof is switched from a standby position via a preparation position to a brushing position (described later), and vice versa. However, this switching is conducted for the sheet of paper, and in the case of the paper P, the brushing members 52 are kept in the standby position without switching the position of the brushing members 52 to the preparation position and the brushing position. Hence, a configuration of the brushing unit 90 will be below described about the case where the sheet of paper is fed and the blank part in the rear-edge part thereof is cut off.

The base portion 92c of the body portion 92 is provided with a position-switching drive motor 94 rotatable in the forward and reverse directions and forming a part of the position switching unit switching the position of the brushing member. A drive gear 94a is connected to the position-switching drive motor 94 and engages the motor connection gear 93a, and thereby, the driving torque of the position-switching drive motor 94 is transmitted to the rotating shaft 93 via the drive gear 94a and the motor connection gear 93a. As a result, the rotating shaft 93 rotates about the axis thereof to turn the brushing members 52 together therewith. In addition, the upper and lower guide members 91 are each formed with four notches 91a ranging from the downstream edge to a middle part thereof in the printer front-and-rear directions and corresponding to the arrangement positions of the four brushing members 52 in the printer right-and-left directions. The four notches 91a are used for preventing the brushing members 52 from interfering with the guide members 91 when the brushing members 52 turn around the center of the rotating shaft 93.

The base portion 92c of the body portion 92 is provided with a sensor shaft bracket 95 arranged substantially in the middle thereof in the printer right-and-left directions. The sensor shaft bracket 95 supports a sensor shaft 96 extending parallel to the rotating shaft 93 in the printer right-and-left directions such that the sensor shaft 96 is rotatable.

A sensor gear 96a is provided in the middle in the axial directions of the sensor shaft 96 such that it rotates unitedly with the sensor shaft 96. The sensor gear 96a engages the sensor connection gear 93b, and thereby, for example, as the rotating shaft 93 rotates counterclockwise in FIGS. 8A and 8B (the position-switching drive motor 94 rotates in the forward direction), the driving torque thereof is transmitted to the sensor shaft 96 via the sensor connection gear 93b and the sensor gear 96a to rotate the sensor shaft 96 clockwise in FIGS. 8A and 8B.

A first sensor plate 54a and a second sensor plate 54b are attached to both ends of the sensor shaft 96 respectively such that the sensor plates 54a and 54b have a different phase from each other. The front side wall 92a of the body portion 92 is provided with a first detection sensor 55a and a second detection sensor 55b which are of a transmission type and detect the first sensor plate 54a and the second sensor plate 54b respectively. The detection results of the first and second detection sensors 55a and 55b are combined to detect the position of the brushing members 52, or where they are located among the standby position, the preparation position and the brushing position. This will be later described in detail.

FIGS. 8A and 8B show the brushing member 52 located in the standby position. The standby position is a position where the brushing member 52 (the front end portion 52a) retreats over the upper guide member 91 from the feeding path. When the sheet of paper after printed is fed to the position of the cutting unit 50, in order to permit the feeding of the sheet of paper, the brushing member 52 (the front end portion 52a) is brought to the standby position where it retreats from the feeding path. Therefore, the brushing member 52 will not hamper the feeding of the sheet of paper up to the cutting unit 50.

In the standby position, as shown in FIG. 8A, the first detection sensor 55a detects the first sensor plate 54a, while as shown in FIG. 8B, the second detection sensor 55b does not detect the second sensor plate 54b.

FIGS. 9A and 9B show the brushing member 52 (the front end portion 52a) located in the preparation position. The preparation position is a position upstream from the brushing position (described later) (a position between the standby position and the brushing position in the turning directions of the brushing member 52) where the brushing member 52 (the front end portion 52a) comes into the feeding path. After the blank part of the rear-edge part of the sheet of paper reaches the position where the cutting unit 50 is supposed to cut the sheet of paper and before the cutting unit 50 cuts the sheet of paper, the position-switching drive motor 94 rotates in the forward direction, and thereby, the brushing member 52 (the front end portion 52a) located in the standby position shown in FIGS. 8A and 8B rotates counterclockwise in FIGS. 8A and 8B and comes to the preparation position.

In this manner, the brushing member 52 is brought to the preparation position, and thereafter, the cutting unit 50 comes into operation and cuts off the blank part of the rear-edge part of the sheet of paper kept halted without being fed. The piece of waste paper produced by the cutoff may be left near the cutting unit 50 (between end parts on the downstream side of the upper and lower guide members 91) on the upstream side with respect to the cutting unit 50 on the feeding path. The piece of waste paper may also move upstream along the feeding path between the upper and lower guide members 91 by the cutoff. However, in the illustrative embodiment, the brushing member 52 (the front end portion 52a) is located in the preparation position, and hence, even if the piece of waste paper attempts to move upstream, the piece of waste paper comes into contact with the brushing member 52 (the front end portion 52a) located in the preparation position. As a result, the piece of waste paper is prevented from moving upstream from the brushing member 52 and remains between the end parts on the downstream side of the upper and lower guide members 91. As described later, the brushing member 52 moves to the brushing position to certainly brush down the piece of waste paper.

In the preparation position, as shown in FIG. 9A, the first detection sensor 55a detects the first sensor plate 54a, and as shown in FIG. 9B, the second detection sensor 55b also detects the second sensor plate 54b.

FIGS. 10A and 10B show the brushing member 52 located in the brushing position. The brushing position is a position where the brushing member 52 (the front end portion 52a) comes into the feeding path and the piece of waste paper is brushed down. After the blank part of the rear-edge part of the sheet of paper is cut off, the position-switching drive motor 94 rotates in the forward direction, and thereby, the brushing member 52 (the front end portion 52a) located in the preparation position shown in FIGS. 9A and 9B rotates counterclockwise in FIGS. 9A and 9B and comes to the brushing position. Specifically, the brushing member 52 (the front end portion 52a) moves up to the position (near the cutting unit 50 on the upstream side with respect to the cutting unit 50 on the feeding path) where the piece of waste paper is left. Then, the brushing member 52 forcedly brushes down (pushes out) the piece of waste paper from the feeding path (between the upper and lower guide members 91) to the downstream side of the guide members 91. The piece of waste paper brushed down falls into the trash can.

In the illustrative embodiment, irrespective of whether the piece of waste paper is left on the feeding path, the brushing member 52 is brought to the brushing position after the blank part of the rear-edge part of the sheet of paper is cut off. This is because the piece of waste paper is highly probably left on the feeding path. Depending on the possibility, whether the piece of waste paper is left on the feeding path after the cutoff may be detected, and if the piece of waste paper is left thereon, the brushing member 52 may be brought to the brushing position. If the piece of waste paper is not left thereon, then before the next sheet of paper comes between the upper and lower guide members 91, the position-switching drive motor 94 rotates in the reverse direction to return the brushing member 52 from the preparation position to the standby position.

In the brushing position, as shown in FIG. 10A, the first detection sensor 55a does not detect the first sensor plate 54a, while as shown in FIG. 10B, the second detection sensor 55b detects the second sensor plate 54b.

After the brushing member 52 is brought to the brushing position and before the next sheet of paper comes between the upper and lower guide members 91, the position-switching drive motor 94 rotates in the reverse direction. Therefore, the brushing member 52 (the front end portion 52a) located in the brushing position shown in FIGS. 10A and 10B turns clockwise in FIGS. 10A and 10B and returns to the standby position.

As described above, the detection results of the first and second detection sensors 55a and 55b are combined to detect the position of the brushing member 52, or where it is located among the standby position, the preparation position and the brushing position. In addition, for example, there may be a failure or the like of the drive motor 94. In this case, the rotating shaft 93 is not rotated, and thereby, the front end portion 52a of the brushing member 52 is not brought to the brushing position. However, an error processing can be conducted on the basis of the detection results of the first and second detection sensors 55a and 55b, thereby notifying the operator of an appropriate processing method.

Furthermore, when the cutting unit 50 cuts off the blank part of the rear-edge part of the sheet of paper, the brushing member 52 does not always need to be in the preparation position, and hence, it may be located in the standby position. In this case, the position of the brushing member 52 switches from the standby position to the brushing position, and vice versa. After cutting off the blank part of the rear-edge part of the sheet of paper, the brushing member 52 turns from the standby position to the brushing position and brushes down the piece of waste paper. Thereafter, the brushing member 52 returns to the standby position before the next sheet of paper comes between the upper and lower guide members 91.

On the printer rear side (downstream) from the cutting unit 50, three pressure-type feeding roller pairs 46 are provided which hold the sheet of paper P (and the sheet of paper after the blank parts of the front-edge and rear-edge parts thereof have been cut off) cut off by the cutting unit 50 between and feed it further to the printer rear side.

In the three feeding roller pairs 46, driving rollers 46a arranged under the feeding path are driven by a single feeding-roller motor (not shown), and the rotational speed thereof or the speed of the paper P fed by the feeding roller pairs 46 is variable. Furthermore, the state of each of driven rollers 46b arranged over the feeding path is switchable from a state where it is pressed against the corresponding driving roller 46a to a state where it is not pressed against the corresponding driving roller 46a, and vice versa. The feeding roller pairs 46 come into the non-pressing state before holding the front edge of the sheet of paper P cut off by the cutting unit 50 between. This makes it possible to prevent the front edge of the paper P from hitting and bending against the feeding roller pairs 46 in the pressing state or another kind of trouble. Here, all the driven rollers 46b of the three feeding roller pairs 46 switch simultaneously to the non-pressing state.

The sheet of paper P fed from the feeding roller pairs 46 is fed to a switchback section 72. The switchback section 72 switches the paper P back as described later, and thereby, the paper P is discharged, with the printed surface thereof up, from a discharge port 85 (described later) onto a feeding belt 101 of a conveyor unit 100 (described later).

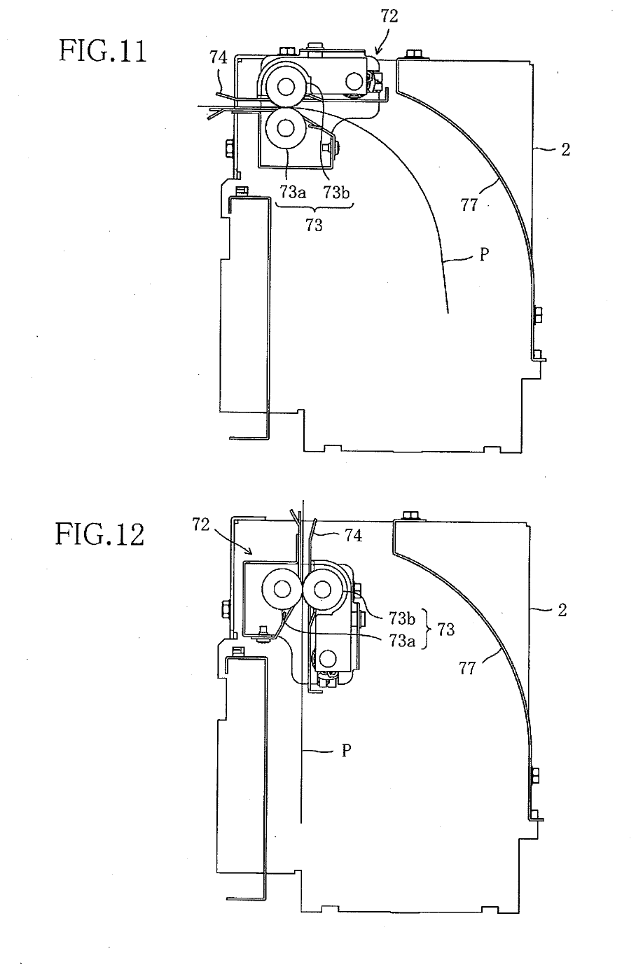

As shown in FIGS. 2 and 11, the switchback section 72 includes a pressure-type switchback roller pair 73 formed by a lower driving roller 73a and an upper driven roller 73b, a pair of first guide members 74 sandwiching the feeding path between on the upstream side from the switchback roller pair 73 and guiding the paper P fed from the feeding roller pairs 46 to the switchback roller pair 73, a pressure-type supply roller pair 75 supplying the switched-back paper P to a back-surface printing unit 60 (described later), and a pair of second guide members 76 which is arranged between the switchback roller pair 73 and the supply roller pair 75, sandwiches the feeding path between and leads the switched-back paper P to the supply roller pair 75.

The driving roller 73a of the switchback roller pair 73 is driven by a switchback-roller drive motor (not shown) and thereby is rotatable in the forward direction such that the driving roller 73a together the driven roller 73b feeds the paper P held between both rollers to the printer rear side and in the reverse direction such that the driving roller 73a together the driven roller 73b feeds the paper P to the printer front side.

The switchback roller pair 73 and the first guide members 74 are turnable in one united body about the rotational axis of the driving roller 73a of the switchback roller pair 73 by a turning motor (not shown). This makes it possible to switch the relative position of the driven roller 73b to the driving roller 73a of the switchback roller pair 73 from a first position substantially right over the driving roller 73a for feeding the paper P to the printer rear side as shown in FIG. 11 to a second position on the printer rear side of the driving roller 73a for feeding the paper P from the rear-edge side of the paper P and supplying the paper P to the back-surface printing unit 60 as shown in FIG. 12, and vice versa.

Here, a description will be given about a switchback operation for switching back the sheet of paper P fed from the feeding roller pairs 46. When the switchback roller pair 73 receives the paper P fed from the feeding roller pairs 46, the driving roller 73a makes a forward rotation and the driven roller 73b is in the first position. Then, the switchback roller pair 73 feeds the paper P to the printer rear side by a certain distance, and when the rear edge of the paper P reaches the first guide members 74 (see FIG. 11), the driving roller 73a stops rotating in the forward direction.

At this time, a front-edge part of the paper P is bent and deflected downward by the weight of the paper P itself. If the paper P is not deflected by the weight because of the great flexural stiffness thereof, the front edge of the paper P comes into contact with a bent guide plate 77 provided downstream from the switchback roller pair 73 and thereby is bent downward along the bent guide plate 77.

Next, the switchback roller pair 73 and the first guide members 74 are turned clockwise in FIG. 11 to switch the position of the driven roller 73b from the first position to the second position. Therefore, the rear-edge side (on the printer rear side) of the paper P is raised and the front-edge side of the paper P is hung by the weight of the paper P itself, and hence, the paper P is vertically extended.

Thereafter, the driving roller 73a rotates in the reverse direction and feeds the paper P from the rear-edge side of the paper P toward the supply roller pair 75 arranged above it. In this manner, the paper P is switched back, and then, the switched-back paper P passes through the first guide members 74 and the second guide members 76 and reaches the supply roller pair 75.

In the illustrative embodiment, the driven roller 73b turns around the driving roller 73a of the switchback roller pair 73, thereby switching the position of the switchback roller pair 73 from the first position to the second position, and vice versa. However, the present invention is not limited to this, and for example, both the driving roller 73a and the driven roller 73b may be movable to switch the position of the whole switchback roller pair 73 from the first position to the second position, and vice versa.

Furthermore, in the illustrative embodiment, the switchback roller pair 73 is formed by the driving roller 73a feeding the paper P and the driven roller 73b driven and rotated by the driving roller 73a. However, both rollers constituting the switchback roller pair 73 may be driving rollers.

As shown in FIG. 2, upstream from the supply roller pair 75, a fourth sensor 43 (formed by a light-injection portion and a light-reception portion) is provided which detects the front edge of the paper P sent from the switchback roller pair 73.

The supply roller pair 75 is formed by a driving roller 75a driven by a supply-roller drive motor (not shown) and a driven roller 75b pressed against the driving roller 75a. The state of the driven roller 75b is switchable to a state where it is not pressed against the driving roller 75a.

On the downstream side with respect to the supply roller pair 75, the back-surface printing unit 60 is provided which prints a serial number on the back surface (reverse to the printed surface) of the paper P. Downstream from the back-surface printing unit 60, four pressure-type downstream roller pairs 78 are provided which are each formed by a driving roller 78a arranged on the printer front side of the vertical feeding path and a driven roller 78b arranged on the printer rear side thereof. All the driving rollers 78a are driven by a single motor (not shown).

The back-surface printing unit 60 is a dot-impact printing unit and includes an ink ribbon cassette 61 housing an ink ribbon 65 and a printing head 62 pressing the ink ribbon 65.

The ink ribbon 65 housed in the ink ribbon cassette 61 carries ink, is folded in the ink ribbon cassette 61 and is held between the rollers of a ribbon-feeding roller pair 63 inside of the ink ribbon cassette 61. The ink ribbon cassette 61 is formed at the front end thereof with an opening portion for the passage of the ink ribbon 65. The ink ribbon 65 is looped and is forwarded with held between the rollers of the ribbon-feeding roller pair 63, and a part thereof is exposed through the opening portion to the outside thereof.

The printing head 62 is provided with a plurality of needle pins 64 each making a reciprocating motion in the axial direction thereof. The printing head 62 allows the needle pins 64 to press the part of the ink ribbon 65 exposed through the opening portion. The ink ribbon 65 pressed by the needle pins 64 is pressed onto the back surface of the paper P and the ink carried thereby is transferred thereon to print the back surface of the paper P.

A drying unit 56 is provided downstream from the back-surface printing unit 60 (on the side opposite to the back-surface printing unit 60 (on the printed-surface side) with respect to the feeding path). The drying unit 56 blows dry air onto the printed surface of the paper P to dry the ink which has adhered to the printed surface of the paper P in the printing section 21. The drying unit 56 includes plural suction fans 57 sucking air into the drying unit 56, plural heaters 58 heating air sucked by the suction fan 57, and plural blowoff nozzle portions 59 opening on the printer front side of the drying unit 56 and blowing air heated by the heater 58 as the dry air onto the printed surface of the paper P. The suction fan 57, the heater 58 and the blowoff nozzle portion 59 are arranged vertically in two tiers.

Here, the degree to which the drying unit 56 dries the ink varies according to ambient conditions (such as temperature and humidity) where the ink jet printer A is installed. Taking this into account, the rotational speed of the downstream roller pairs 78 is designed to be variable, thereby making the feeding speed of the paper P variable. A fifth sensor 44 (formed by a light-injection portion and a light-reception portion) detecting the front edge of the paper P is provided downstream from the drying unit 56.

The downstream roller pairs 78 feed the paper P dried by the drying unit 56 to a discharge roller pair 80. The discharge roller pair 80 discharges the printed paper P from the discharge port 85 onto the feeding belt 101 of the conveyor unit 100. The feeding path extends horizontally at the discharge roller pair 80 and nearby.

The paper P is curly because it was kept rolled inside of the magazine M, and hence, the paper P needs to undergo de-curling and thereby go out of curl. The de-curling is conducted by the discharge roller pair 80. Specifically, the discharge roller pair 80 includes a feeding roller 81 arranged under the feeding path and feeding the paper P, and a de-curling roller 82 arranged over the feeding path and holding the paper P between the de-curling roller 82 and the feeding roller 81. The feeding roller 81 is provided on the upstream side thereof with a free roller 83 rotated along with the movement of the paper P while being fed thereon.

The relative position of the de-curling roller 82 to the feeding roller 81 is switchable from a feeding position (substantially right over the feeding roller 81) where the de-curling roller 82 feeds the paper P without de-curling it to a de-curling position (between the feeding roller 81 and the free roller 83) up to which the de-curling roller 82 moves clockwise in FIG. 2 along the peripheral surface of the feeding roller 81 from the feeding position and where the de-curling roller 82 feeds the paper P while de-curling it, and vice versa. In the de-curling position, the de-curling roller 82 de-curls and feeds the paper P with curled in the direction opposite to the curl direction thereof. In the case of the sheet of paper manually supplied to the manual tray 7, the de-curling roller 82 is located in the feeding position and is not supposed to de-curl the paper P.

The feeding roller 81 sends the paper P to the printer front side and discharges it from the casing 2 through the discharge port 85 formed in the casing 2. As shown in FIG. 1, the feeding belt 101 of the conveyor unit 100 is arranged on the printer front side of the discharge port 85 (the front side in the discharge direction of the paper P with respect to the discharge port 85) in the upper face of the casing 2. The feeding belt 101 receives the paper P discharged through the discharge port 85 from the casing 2 and feeds the received paper P in the printer right-and-left directions. The feeding belt 101 extends in the printer right-and-left directions (the directions perpendicular to the discharge direction of the paper P).

The conveyor unit 100 includes the feeding belt 101, a driving roller 102 driving the feeding belt 101 and a feeding body portion 103 supporting the driving roller 102 such that it is rotatable. The driving roller 102 is rotatable in the forward direction such that the paper P on the feeding belt 101 is fed in the one direction (toward the side where a stacking unit 110 is provided (toward the right side if seen from the printer front side)) of the printer right-and-left directions and in the reverse direction such that the paper P on the feeding belt 101 is fed in the other direction (toward the side where a large-sized tray 104 is provided (toward the left side if seen from the printer front side)) of the printer right-and-left directions.

The part of the feeding belt 101 facing the discharge port 85 of the casing 2 is a placement area for receiving the paper P just discharged from the discharge port 85. The conveyor unit 100 controls the drive of the feeding belt 101 such that when the paper P is discharged from the discharge port 85, the feeding belt 101 is kept stopped and receives the paper P in the placement area, and before the paper P subsequently discharged is placed on the placement area, the feeding belt 101 retreats the paper P already placed on the placement area from the placement area. This prevents the sheets of paper P from being placed one on top of the other on the feeding belt 101, thereby suppressing color shading or the like in a printed image which may be caused by the ink not uniformly dried on the paper P.

Instead of the intermittent feeding in which the feeding belt 101 feeds the already-placed paper P out of the placement area before feeding the subsequent paper P, the feeding belt 101 may continue being driven at a fixed speed.

If the sheet of paper P having a regular photograph size such as an L print is placed on the feeding belt 101, the drive of the feeding belt 101 is controlled such that the feeding belt 101 feeds the paper P toward the stacking unit 110. In contrast, if the sheet of paper P having a large size is placed on the feeding belt 101, the drive thereof is controlled such that the feeding belt 101 feeds the paper P toward the large-sized tray 104. In this manner, the feeding direction is switchable according to the size of the paper P, and thereby, the paper P can be fed to a suitable position for each paper size.

Without the large-sized tray 104, the feeding belt 101 may feed the sheet of paper P (having a regular photograph size) only in the one direction (toward the side where the stacking unit 110 is provided) of the printer right-and-left directions. In this case, the feeding belt 101 is not supposed to be driven even if the feeding belt 101 receives the sheet of paper P having a large size.

The stacking unit 110 assorts and stacks the sheets of paper P fed by the conveyor unit 100 (the feeding belt 101). The stacking unit 110 includes a box-shaped stacking body portion 111 opening on the printer front side thereof, a stacking belt 113 having no end which runs on a roller pair (not shown) provided at both upper and lower ends inside of the stacking body portion 111 such that the stacking belt 113 has a suitable tension, and a plurality of stacking plates 112 arranged at substantially regular intervals on the peripheral surface of the stacking belt 113. The roller pair is connected to a drive motor (not shown) rotating the stacking belt 113 and moving the stacking plates 112 in a conveyance direction thereof.

Among the plurality of stacking plates 112, the stacking plates 112 exposed outward from the stacking body portion 111 move downward as the stacking belt 113 rotates. On the other hand, the stacking plates 112 located inside of the stacking body portion 111 move upward as the stacking belt 113 rotates. In other words, the stacking plates 112 are continuously rotatable together with the stacking belt 113 around the roller pair.

One of the stacking plates 112 stands by in a delivery position near the downstream edge of the feeding belt 101 in the feeding direction of the sheet of paper P having a regular photograph size such that the plate surface thereof is horizontal and is flush with the surface of the feeding belt 101. The paper P is delivered from the feeding belt 101 to the stacking plate 112 in the delivery position and is stacked on the preceding paper P. After the sheets of paper P corresponding to a predetermined printing order are stacked, the sheets of paper P are fed downward by the stacking belt 113 before the sheets of paper P for the next order are fed.

Specifically, first, the sheets of paper P are stacked on the stacking plate 112 located in the delivery position (where the stacking plate 112 horizontally stands by to stack the sheets of paper P). For example, the sheets of paper P for one order are stacked on the stacking plate 112.

Next, the stacking belt 113 is driven to move the stacking plate 112 downward by the interval between the stacking plates 112. In other words, the stacking plate 112 having the sheets of paper P for the one order thereon moves downward, and thereby, the next stacking plate 112 comes to the delivery position.

The above stacking and feeding are repeated according to each order, and thereby, the sheets of paper P for each order can be stacked and fed on each stacking plate 112. Then, the operator picks up and collects the sheets of paper P stacked on each stacking plate 112.

A vertically-erected guide plate 115 is provided in the part of the stacking body portion 111 corresponding to the delivery position. The guide plate 115 stops the sheet of paper P delivered to the stacking plate 112 from the conveyor unit 100 (the feeding belt 101) (the sheet of paper P sent out of the feeding belt 101) by letting the sheet of paper P come into contact with the guide plate 115. Hence, the guide plate 115 is used for stacking the sheets of paper P on the stacking plate 112 with the front edges of the sheets of paper P in the feeding direction of the feeding belt 101 being aligned.

In the illustrative embodiment, the cutting unit 50 is a so-called guillotine cutter which includes the fixed blade 50a and the moving blade 50b vertically arranged such that the paper P (and the sheet of paper) is located between them. However, a roller cutter may be employed which cuts the paper P (and the sheet of paper) by moving a round blade from one end to the other end of the paper P (and the sheet of paper) in the width directions while rotating the round blade.

Furthermore, in the illustrative embodiment, the ink jet printer A is described as an example of the image forming apparatus of the present invention. However, the present invention may be applied to any image forming apparatus feeding paper (particularly, a sheet of paper) and forming an image on the paper.

The above illustrative embodiment is merely an illustration and the scope of the present invention should not be limitedly interpreted. The scope of the present invention should be defined by the claims, and all variations and modifications that fall within metes and bounds of the claims or equivalence of such metes and bounds can be implemented within the scope of the present invention.

What is claimed is:

1. An image forming apparatus feeding paper and forming an image on the paper, comprising:
a cutting unit configured to cut the paper located on a feeding path to feed a sheet of paper subjected to the image formation; and
a brushing unit arranged on the upstream side in the paper feeding direction with respect to the cutting unit and after the cutting unit cuts the paper, brushing down, from the feeding path, a piece of waste paper left near the cutting unit on the upstream side in the paper feeding direction with respect to the cutting unit on the feeding path.

2. The image forming apparatus of claim 1, wherein
the brushing unit includes
a brushing member brushing down the piece of waste paper, and
a position switching unit switching the position of the brushing member from a standby position where the brushing member retreats from the feeding path for the paper to a brushing position where the brushing member comes into the feeding path and brushes down the piece of waste paper, and vice versa.

3. The image forming apparatus of claim 2, wherein
the position switching unit switches the position of the brushing member before the cutting unit cuts the paper to a preparation position which is on the upstream side in the paper feeding direction with respect to the brushing position and in which the brushing member comes into the feeding path.
